(19) United States
(12) Patent Application Publication
(10) Pub. No.: US 2017/0311741 A1
(43) Pub. Date: Nov. 2, 2017

(54) INFUSER

(71) Applicant: Chadwick SHEPHERD, Lake Worth, FL (US)

(72) Inventor: Chadwick SHEPHERD, Lake Worth, FL (US)

(21) Appl. No.: 15/523,202

(22) PCT Filed: Oct. 30, 2015
(86) PCT No.: PCT/US15/58412

§ 371 Date: Apr. 28, 2017

Related U.S. Application Data
(60) Provisional application No. 62/073,794, filed on Oct. 31, 2014.

(51) Int. Cl. A47G 19/16; A47J 31/20; A47G 19/14

(52) U.S. Cl. CPC A47G 19/16; A47G 19/14; A47J 31/20

(57) ABSTRACT

An infuser having a substantially arcuate water holding portion detachably coupled to a stand. A material retaining portion and an insertion handle coupled to the material retaining portion and the stand. The insertion handle is configured to pivot whereby the material retaining portion can be moved between an unsubmerged configuration and a submerged configuration.

### CROSS-REFERENCED TO RELATED APPLICATIONS

The present application claims benefit to U.S. Provisional Application No. 62/073,794, filed Oct. 31, 2014, the entire contents of which are incorporated by reference.

### FIELD

The present disclosure relates to an infuser that is configured to receive tea leaves and water, more specifically an infuser.

### BACKGROUND

In order to make tea, tea leaves are placed into contact with water. In at least one traditional method, the tea leaves are placed directly into the water. As some people do not like having the tea leaves enter their mouths, strainers and/or tea leaf restriction devices were created. In one example, an infuser can be a ball shaped object with holes. In other examples, an infuser can be a bag.

### BRIEF DESCRIPTION OF THE DRAWINGS

Embodiments of the present application will now be described, by way of example only, with reference to the attached Figures, wherein:

FIG. 1 is an isometric view of an example embodiment of an infuser having a filter in an open configuration;

FIG. 2 is a left side view of the infuser of FIG. 1;

FIG. 3 is a right side view of a second embodiment of an infuser;

FIG. 4 is a front view of the infuser of FIG. 1;

FIG. 5 is a rear view of the infuser of FIG. 1;

FIG. 6 is a bottom view of an example embodiment of an infuser of FIG. 1 having a filter in an up position; and

FIG. 7 is a left side view of the infuser of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other thing that “substantially” modifies, such that the component need not be exact. For example, substantially cylindrical means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

The present technology can be implemented as an infuser. For example, the infuser can be included as part of an infuser or other infusing device. The infuser is configured to retain a material such as tea leaves while allowing water to come into contact with the material.

The present technology can include one or more of the features described herein. While some features are described in relation to a particular figure, the features can be implemented with other embodiments.

An infuser can include a water holding portion having an interior volume, a pouring end and a handle end. The water holding portion can be configured to be detachably coupled to a stand. The infuser can also include a material retaining portion and an insertion handle. The insertion handle can be configured to be coupled to the material retaining portion and the stand. The insertion handle can be configured to pivot about an axis transitioning the material retaining portion between an unsubmerged configured to a submerged configuration. The unsubmerged configuration can also be described as a withdrawn configuration. The submerged configuration can also be described as an inserted configuration. In at least one embodiment, the insertion handle can be coupled to the filter and the stand. In an alternative embodiment, the insertion handle can be coupled to the filter and the water holding portion.

In the unsubmerged configuration, the material retaining portion can be arranged substantially above the water holding portion and configured to allow excess liquid to drain back into the water holding portion. In at least one embodiment, the insertion handle can rest at the rear of the water holding portion, nearest the handle end, when in the unsubmerged configuration. In this embodiment, the insertion handle can rotate from the rear of the water holding portion toward the front of the water holding portion as the filter is submerged in the liquid. In an alternative embodiment, the insertion handle can be configured to rest at the front of the water holding portion, nearest the pouring end, in the unsubmerged configuration. In this embodiment, the insertion handle can rotate from the front of the water holding portion toward the rear of the water holding portion as the material retaining portion is submerged in the liquid. The water holding portion can also include a fill line indicating the appropriate volume of liquid for proper usage. The fill line can assist users in preventing liquid from being displaced outside the water holding portion, when transitioning the material retaining portion from up (unsubmereged) to down (submerged) configuration.

In at least one example, the water holding portion can be substantially arcuate and a partial torroid. In at least one example, the water holding portion can be a borosilicate glass tea pot. In yet another example, the water holding portion can be double walled for improved heat retention.

The material retaining portion can be configured to transition into the interior volume of the water holding portion when in the submerged configuration. In at least one example, the material retaining portion can be substantially arcuate and partially toroid. In another example, the material retaining portion can have a substantially circular cross-section.

The material retaining portion can, alternatively, take any shape capable of being submerged within the interior volume of the water holding portion.

In the submerged configured, the material retaining portion can be arranged substantially inside the water holding portion. The filter can be substantially submerged in the volume of liquid. In at least on example, when the water holding portion contains no liquid the material retaining portion can be filled with infusion material while in the submerged configuration. When the water holding portion contains liquid, the filter can infuse the liquid while in the submerged configuration.

In at least one embodiment, the water holding portion can include a lid having an aperture. The material retaining portion can be configured to pass through the aperture when transitioning from one configuration to another. In at least one embodiment, the aperture can be slightly larger than the material retaining portion. In another embodiment, the aperture can be significantly larger than the material retaining portion. The aperture can be configured to allow the movable filter to drain excess liquid into the water holding portion when in the unsubmerged configuration. In yet another embodiment, the water holding portion can have two lids, one covering the pouring end and another covering handle end. Depending on the arrangement of the water holding portion, one lid can be solid, and the other lid can have an aperture configured to receive the material retaining portion. The solid lid can be configured to have ventilation to prevent an air bubble from forming in the opposite end of the toroid. In at least one example, the ventilation can be a one way valve.

The water holding portion can also include a pouring lip at the pouring end. The pouring lip can be configured to assist in removing liquid from the water holding portion. The pouring lip can focus a stream of liquid, assisting with accurate pouring, and reducing spills. In at least one embodiment, the pouring lip can be formed into pouring end of the water holding portion. In another embodiment, the pouring lip can be formed into the stand and configured to operably couple with an aperture in the water holding portion. In at least one embodiment, the lid can be solid or formed with an aperture based on the material retaining portion arrangement, can be configured to lift slightly as the water holding portion is tipped for pouring, and the liquid can be directed by the pouring lip formed into the stand.

The material retaining portion can be coupled to the insertion handle and configured to rotate the filter from an unsubmerged configuration to a submerged configuration. The material retaining portion can also include varying surface portions. The varying surface portions can include one or more solid surface portions and mesh surface portions. In at least one embodiment, the filter can have an upper surface comprised of a mesh material and a lower surface comprised of a non-mesh material. The mesh material can be any water permeable material configured for use with food. Ideally, the mesh material has sufficient permeation to allow liquid to freely permeate infusion material yet also dense enough to prevent infusion material from leaving the material retaining portion. The non-mesh material can be a non-water permeable material configured to prevent liquid from dripping when in an unsubmerged configuration. In an alternative embodiment, the lower surface can also include a drainage trough to direct liquid back down into the water holding portion. In another embodiment, the filter can have a substantially circular cross-section where an upper portion of the circumference is a mesh material and a lower portion of the circumference is a solid material. The lower portion of the filter can include a drainage trough configured to direct liquid back into the water holding portion when the filter is in the up (unsubmerged) position. In an alternative embodiment, the entire surface of the filter can have a mesh surface.

The material retaining portion can include a closeable aperture at one end allowing the filter to be filled with infusion material. The filter can be configured to receive infusion material in either the up (unsubmerged) or down (submerged) configuration. Ideally, the water holding portion will have little to no liquid when adding infusion material with the material retaining portion in the down position. In at least one embodiment, the infusion material can be tea leaves. In other embodiments, the mesh portion can include a hinged or other openable portion that can be opened and closed, thereby allowing insertion and removal of the material.

The stand can be detachably coupled to the water holding portion. The stand can have a plurality of legs support the water holding portion. In at least one embodiment, the legs can allow the water holding portion to remain elevated above a surface, thus preventing heat damage to surfaces when the water holding portion is set down. In at least one embodiment, the stand can have three legs with one leg forming a handle configured to allow a user to lift and operate the water holding portion. In an alternative embodiment, the stand can have a single leg forming a base upon which to rest the water holding portion.

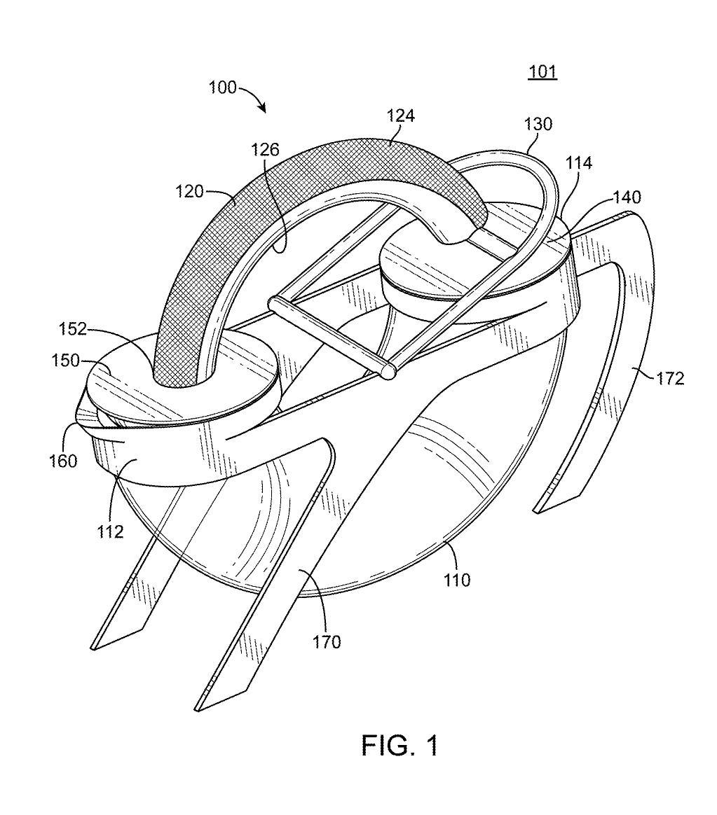

FIG. 1 illustrates an infuser 100 having a water holding portion 110 detachably coupled to a stand 170. The water holding portion 110 can have a pouring end 112 and a handle end 114. The water holding portion 110 can be substantially arcuate and form a partial toroid. The water holding portion 110 can have an interior volume configured to hold a volume of liquid. The water holding portion 110 can be borosilicate glass. In at least one embodiment, the water holding portion 110 is double walled for better insulation.

The stand 170 can be configured to detachably couple with the water holding portion 110. The stand 170 can have a plurality of legs configured to elevate the water holding portion 110 above a surface. The elevation can prevent, or reduce, heat transfer from the water holding portion to surfaces. In at least one embodiment, the stand 170 can have three legs with two legs being nearest the pouring end 112 with the other leg being nearest the handle end 114. The leg nearest the handle end 114 can be configured to act as a handle 172 allowing a user to operate the water holding portion 110.

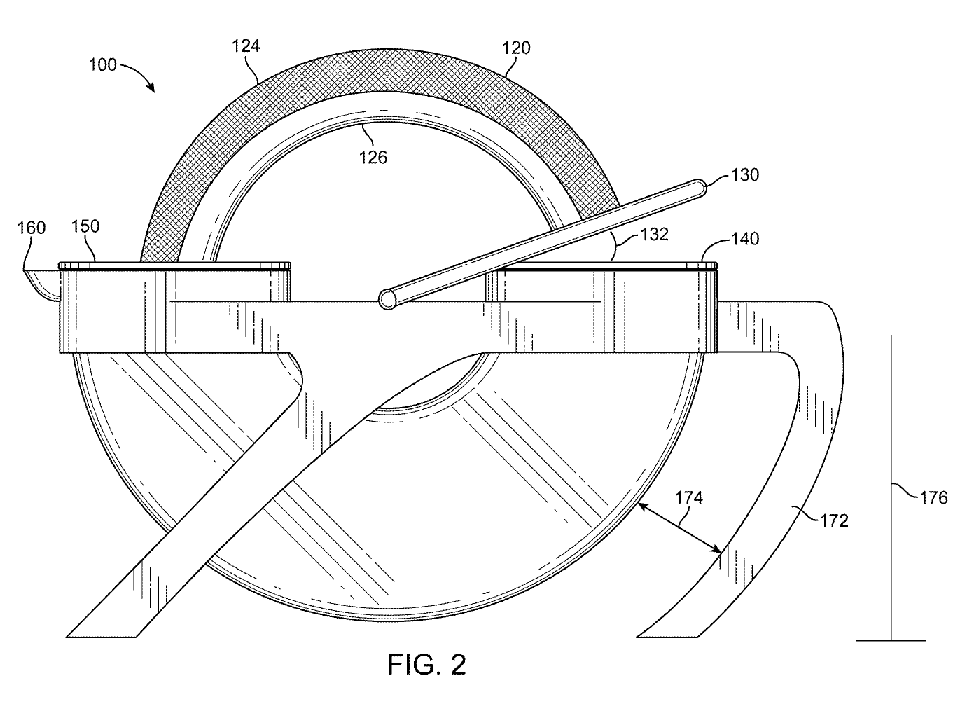

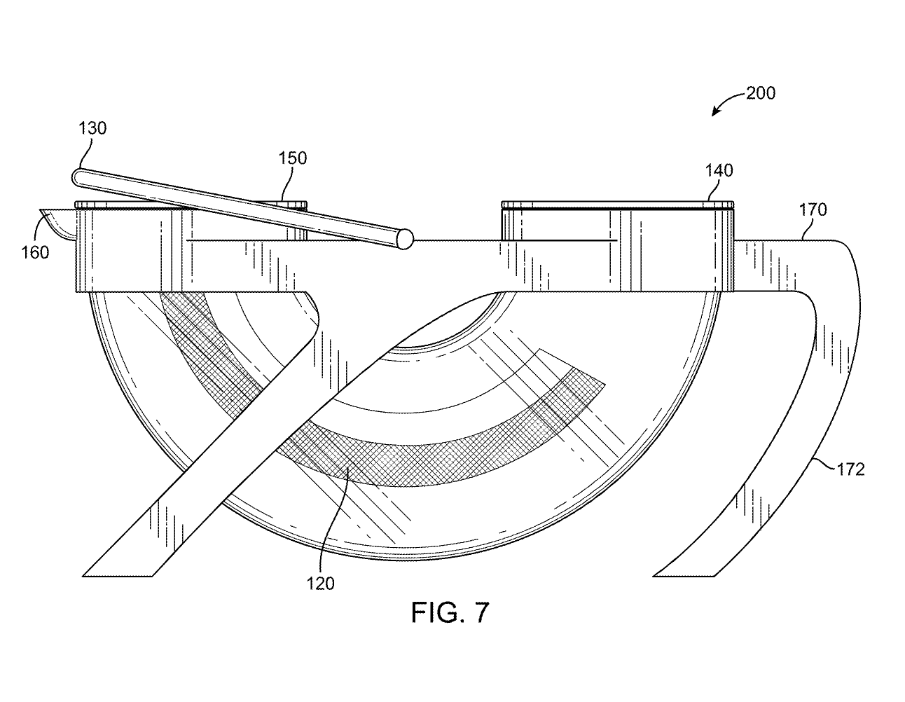

The infuser 100 can have a material retaining portion 120 coupled to a insertion handle 130. As can be appreciated in FIGS. 1-2, the insertion handle 130 can be pivotably coupled to the stand 170. In an alternative embodiment, the insertion handle 130 can be pivotably coupled to the water holding portion 110. The insertion handle 130 can be configured to transition the material retaining portion 120 between an unsubmerged configuration 101 and a submerged configuration 200. (See FIGS. 7 & 8). In at least one embodiment, the material retaining portion 120 rests substantially above of the water holding portion when in the unsubmerged configuration 101. The material retaining portion 120 can be substantially within the interior volume of the water holding portion 110 when in the submerged configuration 200. (See FIGS. 7 & 8).

In the illustrated embodiment, the insertion handle 130 rests at the handle end 114 of the water holding portion when in the unsubmerged configuration 101, and rests at the pouring end 112 when in the submerged configuration 200. In an alternative embodiment, the insertion handle 130 can be configured to rest at the pouring end 112 of the water holding portion when in the unsubmerged configuration 101, and rest at the handle end 114 when in the submerged configuration. In at least one embodiment, the insertion handle 130 can be reversible allowing the direction of pivotation between configurations to be changed by the user.

The material retaining portion 120 can have varying surface portions. The varying surface portions can include solid surface portions 126 and mesh surface portions 124. The mesh surface 124 can be any water permeable material designed for use with food. Ideally, the mesh surface 124 has sufficient permeation to allow liquid to freely permeate infusion material when in a submerged configuration 101 yet also fine enough to prevent infusion material from leaving the material retaining portion 120. The solid surface 126 can be a non-water permeable material configured to prevent liquid from dripping when in an unsubmerged configuration 200.

The material retaining portion 120 can include a closeable aperture at one end allowing the filter to be filled with infusion material. The filter can be configured to receive infusion material in either the up (unsubmerged) 101 or down (submerged) configuration 200 (See FIGS. 7 & 8). Ideally, the water holding portion will have little to no liquid when adding infusion material with the material retaining portion in the down position. In at least one embodiment, the infusion material can be tea leaves. The material retaining portion 120 can also include a drainage trough 128 configured to direct liquid back into the water holding portion 110 when in an unsubmerged configuration 101.

The water holding portion 110 can have two lids, a solid lid 140 and an aperture lid 150.

The aperture lid 150 can have an aperture 152 formed therein. Each lid can be configured to cover one end of the water holding portion 110. Depending on the arrangement of the material retaining portion 120, the lids can be located at either ends of the water holding portion. The aperture lid 150 can be configured to receive the material retaining portion 120 when it transitions between the unsubmerged and submerged configurations. The aperture 152 can be slightly larger than the cross-section of the material retaining portion 120, or substantially larger depending on the design of the water holding portion 110. The two lids can be interchangeable and can be positioned at the appropriate end 112, 114 depending on the arrangement and direction of travel of the material retaining portion 120 and the insertion handle 130.

The water holding portion 110 can also include a pouring lip 160 at the pouring end 112. The pouring lip 160 can be configured to assist in removing liquid from the water holding portion 110. The pouring lip 160 can direct a stream of liquid assisting with accurate pouring, reducing spills. In at least one embodiment, the pouring lip 160 can be formed into pouring end 112 of the water holding portion 110. As can be appreciated in FIGS. 1-2, the pouring lip 160 can be formed into the stand 170 and configured to operably couple with an aperture (not shown) in pouring end 112 of the water holding portion 110. In this arrangement, the lid, either solid or with an aperture depending on filter arrangement, can be configured to, as the water holding portion is tipped for pouring, allow liquid to be directed by the pouring lip formed into the stand.

FIG. 2 illustrates a side view of an infuser 100 with the material retaining portion 120 in an unsubmerged configuration. In at least one example, the insertion handle 130 does not rotate to a completely flush configuration with the lid. The insertion handle 130 forms angle 132 above the solid lid 140. As can be appreciated in FIG. 2, the handle 172 can be positioned a distance from the outer surface of the in water holding portion 101. This distance 174 can be configured to allow a user to grasp the handle without having the outer surface of the water holding portion, the stand 170 can be configured to elevate the infuser 100 above a surface.

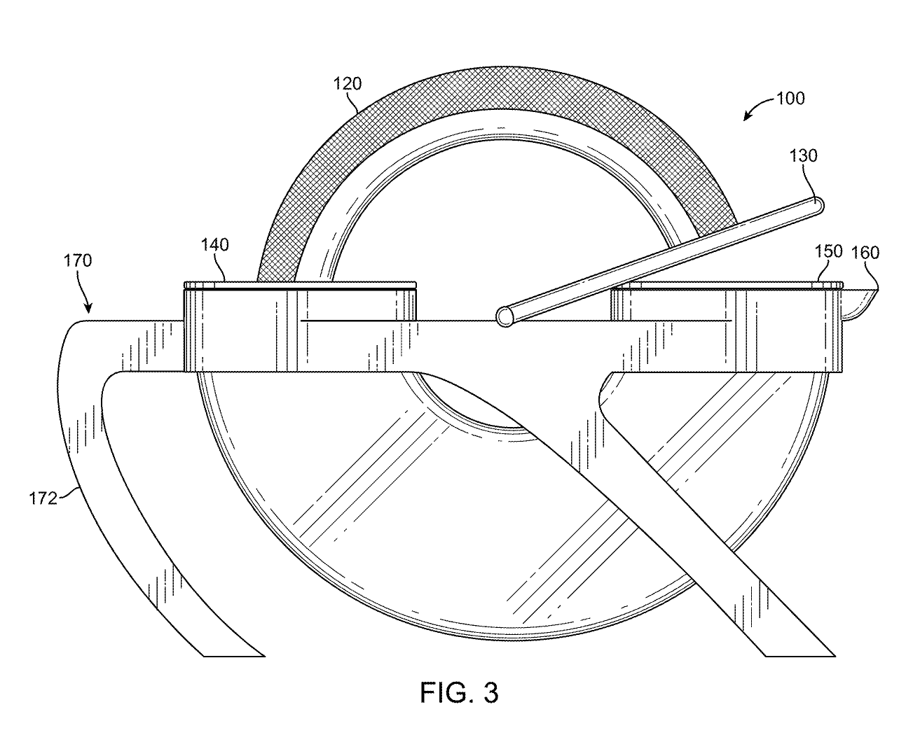

FIG. 3 illustrates an infuser 100 having an insertion handle in a second configuration. The insertion handle 130 can be configured to rest at the pouring end 112 of the water holding portion when in the unsubmerged configuration 101, and rest at the handle end 114 when in the submerged configuration. This configuration allows the rotation of the insertion handle 130 to move from the pouring end 112 to the handle end 114 as the material retaining portion 120 is submerged.

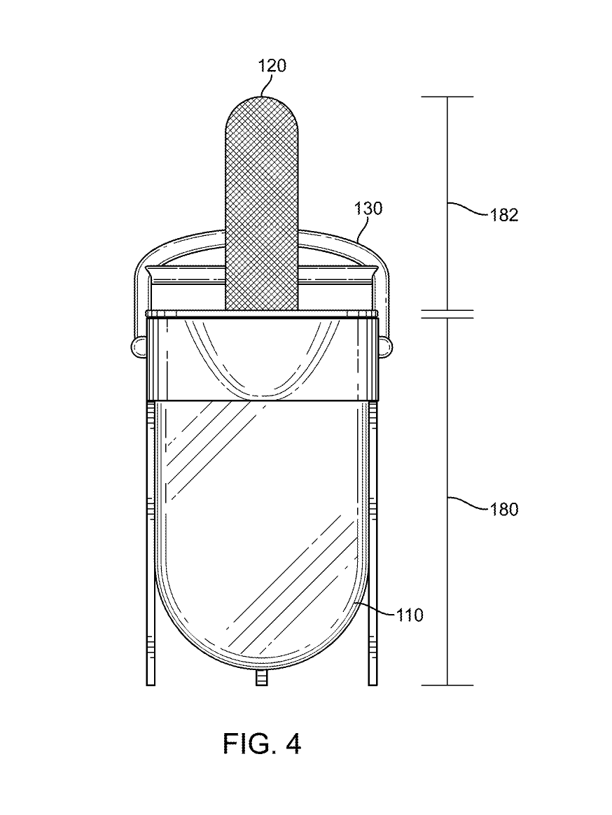

FIG. 4 illustrates an infuser 100 resting in a stand. The height of the infuser 100 can vary depending on the configuration. The water holding portion 110 resting in the stand can have a first height 180. The infuser 100 can be the first height 180 when in the material retaining portion 120 is in a submerged configuration 200. The infuser 100 can have a second height 182 above the water holding portion 110 when the material retaining portion 120 is in an unsubmerged configuration 101.

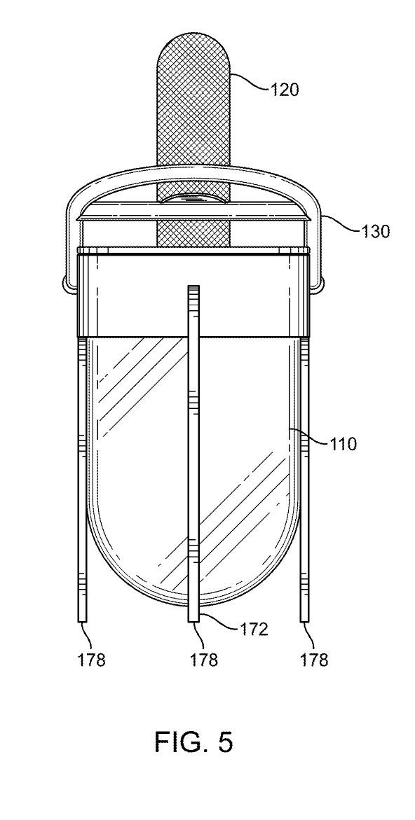

FIG. 5 illustrates the stand 170 having a plurality of legs. The stand can have a plurality of legs support the water holding portion 110. In at least one embodiment, the legs can have a height 176 configured to allow the water holding portion to remain elevated above a surface, thus preventing heat damage to surfaces when the water holding portion is set down. The bottom portion of each leg 178 can be configured to rest on a surface providing stability for the infuser 100. In at least one embodiment, the stand can have three legs with one leg foiming a handle 172 configured to allow a user to lift and operate the water holding portion.

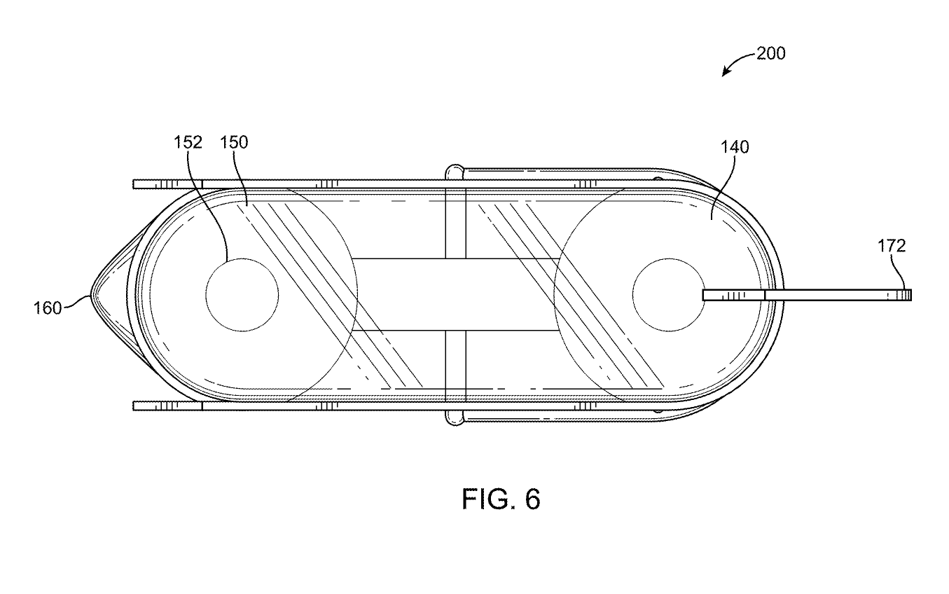

FIG. 6 illustrates an infuser 100 with the material retaining portion 120 in an unsubmerged configuration 200. The insertion handle 130 is in an up position causing the material retaining portion 120 to be in an unsubmerged configuration. In this configuration the material retaining portion 120 is substantially outside the interior volume of the water holding portion 110.

As can be appreciated in FIG. 7, the insertion handle 130 can be in a down position causing the material retaining portion to be in a submerged configuration. In this configuration, the material retaining portion 120 can be substantially within the interior volume of the water holding portion 110. As may be further appreciated by FIG. 7, the material retaining portion 120 can have a complimentary arcuate shape with respect to the water holding portion 110. The complimentary shape can improve even water contact with the infusion material. The shape of the material retaining portion 120 can help ensure the entire volume of the water holding portion 110 has adequate water contact creating evenly infuser water.

Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure to the full extent indicated by the broad general meaning of the terms used in the attached claims. It will therefore be appreciated that the examples described above may be modified within the scope of the appended claims.

What is claimed is:

1. An infuser comprising:
a substantially arcuate water holding portion having a pouring end and a handle end wherein the water holding portion is configured to be coupled to a stand;
a material retaining portion; and
a insertion handle coupled to the material retaining portion and the stand, wherein the insertion handle is configured to pivot whereby the material retaining portion can be moved between an unsubmerged configuration and a submerged configuration.

2. The infuser of claim 1, further comprising a lid having an aperture and configured to be coupled to one end of the kettle, wherein the material retaining portion is configured to pass through the aperture.

3. The infuser of claim 1, wherein the kettle forms a pouring lip at the pouring end of the kettle.

4. The infuser of claim 1, wherein the material retaining portion has an upper surface comprised of a mesh material and a lower surface comprised of a non-mesh material.

5. The infuser of claim 1, wherein the stand has at least one leg.

6. The infuser of claim 1, wherein the stand a plurality of legs and at least one leg is configured to be a handle.

7. The infuser of claim 1, wherein the water holding portion forms an aperture in the pouring end configured to pour and the stand forms a pouring lip.

8. The infuser of claim 1, wherein the water holding portion is substantially arcuate.

9. The infuser of claim 8, wherein the material retaining portion pivots on an axis that is substantially equidistance between the pouring end and the handle end.

10. The infuser of claim 9, wherein the material retaining portion transitions into the water holding portion at the handle end.

11. The infuser of claim 9, wherein the material retaining portion transitions into the water holding portion at the pouring end.

12. The infuser of claim 1, further comprising a one-way valve at one end of the water holding portion.
